(19) United States
(12) Patent Application Publication
(10) Pub. No.: US 2005/0210515 A1
(43) Pub. Date: Sep. 22, 2005

(54) Server system for performing communication over wireless network and operating method thereof

(75) Inventors: Young Hoon Roh, Seoul (KR); Jung Ho Kim, Seoul (KR); Jin Cheol Cho, Seoul (KR); Jae Won Chang, Seoul (KR); Sang Hyuk Kang, Pusan (KR); Sang Mahn Kim, Kyunggi-do (KR); Pan Su Kim, Kyunggi-do (KR); Kwang Hui Hong, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 10/896,990

(22) Filed: Jul. 23, 2004

(30) Foreign Application Priority Data
Mar. 22, 2004 (KR) 2004-19411

(51) Int. Cl. H04N 7/16; H04L 12/42; H04L 12/403; H04Q 7/00; H04N 7/18

(52) U.S. Cl. 725/81; 725/80; 725/62

(57) ABSTRACT

Disclosed are a server system for performing moving picture data communication with a client device over a wireless network, and an operating method thereof. A server device compresses the moving picture data received from an external medium at a variably controlled compression rate according to transmission bandwidth of the current wireless network and an image quality level set by a user in response to a request of the client device. Moreover, the server device transmits the compressed moving picture data to the client device in a wireless fashion. Therefore, transmission delay and playback delay can be avoided and data loss is avoided during a data transmission operation, such that stable data communication can be performed.

### BACKGROUND OF THE INVENTION

1. Field of the Invention

The present invention relates to a server system for performing communication over a wireless network and an operating method thereof, and more particularly to a server system for performing communication over a wireless network and an operating method thereof that can ensure transmission bandwidth of a data stream, and ensure quality of service (QoS) for data playback by avoiding data reception delay and playback delay at a client device, as a server device transmitting moving picture data predicts a transmission state of the current network and variably controls a compression rate.

2. Description of the Related Art

A conventional server system for performing communication over a wireless network will be described with reference to FIG. 1.

The server system for performing communication over the wireless network basically includes a server device 10 and one or more client devices, e.g., client devices 20a and 20b. As the server device 10 and the client devices 20a and 20b transmit and receive data over the wireless network, a wireless network modem is mounted in the server device 10 and the client device 20a and 20b.

In this specification, it is assumed that the server device 10 is a home server (e.g., an Internet-based refrigerator) for controlling a home network constructed within a home. Moreover, it is assumed that the client device 20a is a web pad capable of receiving moving picture data from the home server.

The home server 10 coupled to an external medium such as a radio, a television (TV) antenna or etc. can receive moving picture data. Moreover, the home server 10 coupled to a cable network or an Internet network can receive digital contents transmitted from a specific server.

In the case where image or video signals are converted into digital data and the digital data is stored without being compressed, the uncompressed digital data occupies a large storage space of a memory provided in the home server 10 and the wireless network is unstable when the data is transmitted to the client device 20a. Consequently, transmission load on the wireless network increases.

Thus, the home server 10 compresses information of the digital data, such that a memory space can be effectively utilized and a transfer function over the network can be improved.

If the client device 20a makes a moving picture data request, wireless data communication is performed between the home server 10 and the client device 20a.

The client device 20a can be significantly spaced from the home server 10 when it is moved during communication. Alternatively, interference can be caused by the mobile phone 20b during wireless communication. In this case, bandwidth is reduced and hence data transmission delay occurs. Consequently, playback delay in the client device 20a can be caused by the transmission delay.

In particular, where compressed data is transmitted to the client device 20a at a predetermined transmission rate after streaming data is conventionally compressed at a constant data compression rate, reception delay occurs in the client device 20a as long as sufficient reception bandwidth is not ensured according to the compression rate and the transmission rate.

In particular, not only data loss, but also playback delay can be caused by the data reception delay. The home server 10 repeatedly re-transmits data because of the data loss, such that transmission load increases.

As the transmission load in the wireless network communication increases, not only transmission delay at a transmitting stage, but also playback delay at a receiving stage is caused by the increased transmission load.

In this case, as a picture distortion/cutoff phenomenon occurs and image quality is degraded when the client device 20a reproduces data, there is a problem in that the reliability of the overall network system can be degraded.

### SUMMARY OF THE INVENTION

Therefore, the present invention has been made in view of the above problems, and it is one object of the present invention to provide a server system and an operating method thereof that can stably carry out real-time data transmission by taking into account transmission bandwidth of a wireless network between client and server devices and an image quality level acceptable by a user at a client device and variably controlling a data compression rate when a real-time moving picture data stream is transmitted in a wireless network environment.

It is another object of the present invention to provide a server system and an operating method thereof that can ensure quality of service (QoS) in data playback by avoiding data reception delay and playback delay in a client device.

In accordance with an aspect of the present invention, the above and other objects can be accomplished by the provision of a server system for performing communication over a wireless network, comprising: at least one client device for transmitting and receiving data over the wireless network constructed within a building, and setting an image quality level acceptable by a user when moving picture data is reproduced; and a server device for compressing the moving picture data received from an external medium at a variably controlled compression rate according to transmission bandwidth of the current wireless network and the image quality level in response to a request of the client device, and transmitting the compressed moving picture data to the client device in a wireless fashion.

Preferably, the server device comprises: an audio/video (AV) memory for receiving a moving picture data stream transmitted over a cable antenna or an Internet network and storing the received data stream; and a Moving Picture Experts Group (MPEG) encoder for compressing the moving picture data stored in the AV memory at a predetermined compression rate.

In this case, the compression rate of the MPEG encoder is variably controlled by a compression rate controller. The moving picture data to be transmitted in real time is compressed according to the variably controlled compression rate.

A network transmitter receives the moving picture data compressed by the MPEG encoder and transmits the compressed moving picture data to the client device over the wireless network.

The network transmitter generates transmission state information to be transmitted to the client device and feeds back the transmission state information to the compression rate controller. The compression rate controller predicts the transmission bandwidth on the basis of the transmission state information and produces a data compression rate.

The moving picture data transmitted from the server device is received by a network receiver of the client device. An MPEG decoder decompresses the received moving picture data and the display unit externally displays the decompressed moving picture data.

In this case, a network receiver generates reception state information of the received moving picture data. The reception state information is fed back to the compression rate controller of the server device together with image quality level information over a reception information feedback unit, such that the transmission bandwidth and the data compression rate is produced.

As the transmission bandwidth deciding the data transmission rate is produced on the basis of information at the time of transmitting current data and information fed back from the receiving side, a transmission bandwidth prediction error can be reduced.

Moreover, as the data compression rate is adjusted according to transmission load and an image quality level set by the user, a transmission function over the network can be improved by increasing data storing efficiency, and quality of service (QoS) can be stably provided when a moving picture is reproduced.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows a conventional server system for performing communication over a wireless network;

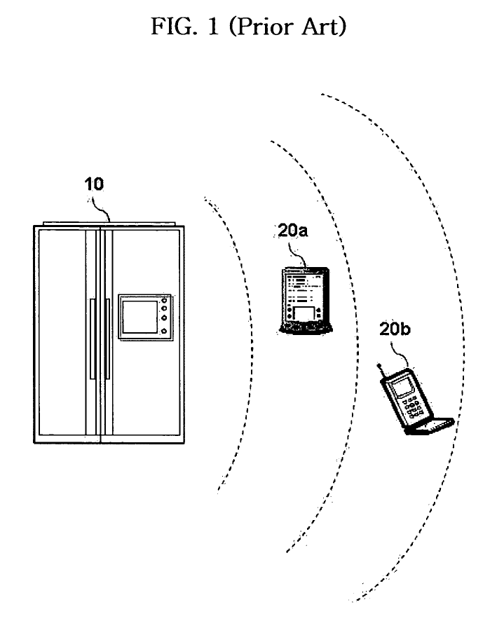

FIG. 2 is a block diagram illustrating a server system for performing communication over a wireless network in accordance with the present invention;

FIG. 3 is a block diagram illustrating a server device in accordance with the present invention;

FIG. 4 is a block diagram illustrating a client device in accordance with the present invention;

FIG. 5A is a flowchart illustrating an operating method of the server device provided in the server system for performing communication over the wireless network in accordance with the present invention; and

FIG. 5B is a flowchart illustrating an operating method of the client device provided in the server system for performing communication over the wireless network in accordance with the present invention.

### DESCRIPTION OF THE PREFERRED EMBODIMENTS

Now, a home network system and an operating method thereof in accordance with preferred embodiments of the present invention will be described in detail with reference to the annexed drawings. The present invention can be implemented by various embodiments. Because basic components of a server system for performing communication over a wireless network are the same as the conventional components, the identical components will not be described in detail.

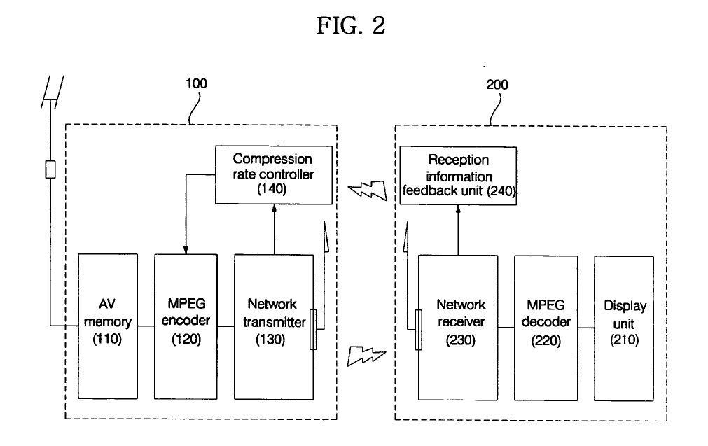

FIG. 2 briefly shows a server device and a client device provided in the server system for performing communication over the wireless network in accordance with the present invention.

The server device 100 and the client device 200 in accordance with the present invention can employ a wireless local area network (LAN) or Bluetooth communication network for transmitting and receiving data based on a radio frequency (RF) signal protocol or Bluetooth protocol in a wireless fashion. The present invention is not limited to the wireless LAN or Bluetooth communication network.

The server device 100 acts as a device capable of controlling or monitoring at least one client device 200 coupled thereto over a network constructed within a home. This embodiment exemplarily defines the server device 100 as an Internet-based refrigerator. It is assumed that the client device 200 is a web pad capable of being attached to or separated from the Internet-based refrigerator is used in this embodiment.

In a state where the web pad is attached to the Internet-based refrigerator, it can be employed as a monitor of the Internet-based refrigerator. Otherwise, in a state where the web pad is separated from the Internet-based refrigerator, it can be employed as the client device 200 performing data communication with the server device 100 in the wireless fashion.

In this case, because the removable web pad is portable, it can perform wireless communication with the server device (e.g., the Internet-based refrigerator) within a predetermined radius from the Internet-based refrigerator.

The server device 100 receives moving picture data for a radio, a television (TV) or etc. over a cable or an antenna or receives digital contents over an Internet network. Then, the server device 100 compresses the moving picture data in response to a request of the client device 200 and transmits the compressed moving picture data to the client device 200.

For this, the server device 100 comprises: an audio/video (AV) memory 110 for receiving a moving picture data stream transmitted over a cable antenna or an Internet network and storing the received data stream; a Moving Picture Experts Group (MPEG) encoder 120 for compressing the moving picture data stored in the AV memory 110 at a predetermined compression rate; and a network transmitter 130 for transmitting the compressed data to the client device 200, as shown in FIG. 2.

Moreover, the client device 200 comprises: a network receiver 230 for receiving data from the server device 100 in the wireless fashion; an MPEG decoder 220 for decompresses-the received data; and a display unit 210 for displaying the decompressed data.

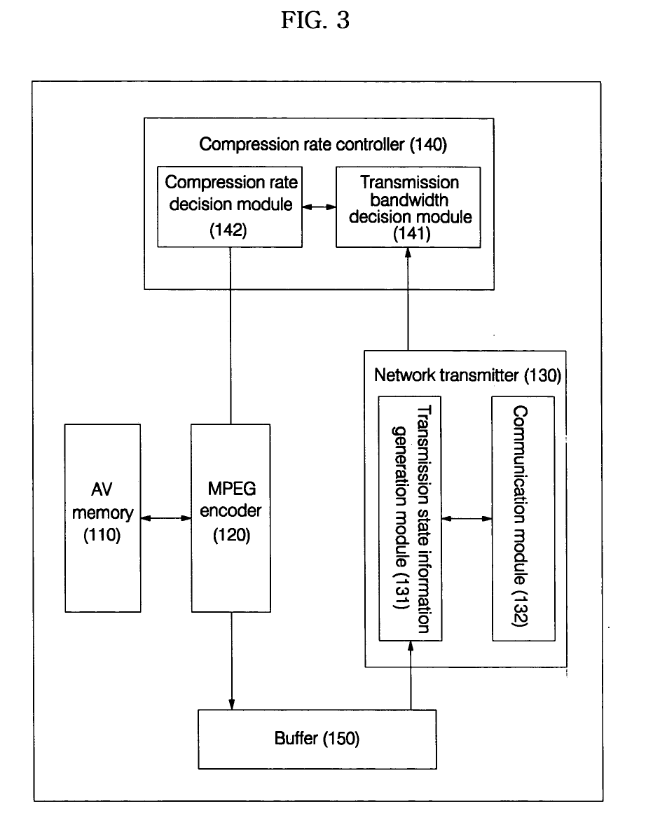

A configuration of the server system for performing communication over the wireless network will be described in detail with reference to FIG. 3. FIG. 3 is a block diagram illustrating the server device in accordance with the present invention.

When the client device 200 sends a moving picture data request to the server device 100, the server device 100 receives a moving picture data stream over the Internet network, the cable network or etc. and stores the received data stream in the AV memory 110.

The MPEG encoder 120 compresses the moving picture data stored in the AV memory 110 and the compressed data is transmitted to the client device 200. At this time, a compression rate controller 140 decides a compression rate of the MPEG encoder 120.

The compression rate controller 140 comprises: a transmission bandwidth decision module 141 for producing transmission bandwidth of the current network on the basis of transmission state information generated from the network transmitter 130 and reception state information transmitted from the client device 200; and a compression rate decision module 142 for variably controlling the compression rate of the MPEG encoder 120 according to the produced transmission bandwidth and an image quality level set in the client device 200.

That is, the compression rate controller 140 predicts the transmission bandwidth and decides a data transmission rate on the basis of a data transmission/reception state between the server device 100 and the client device 200, such that precision of the predicted transmission bandwidth can be improved.

Moreover, as the compression rate of moving picture data varies with the image quality level set by a user and the predicted transmission bandwidth, the compression rate is increased and an amount of data to be transmitted is reduced when transmission load is increased and the transmission delay is caused by the increased transmission load, such that stable data communication can be performed.

According to the compression rate decided by the compression rate decision module 142, the moving picture data compressed by the MPEG encoder 120 is transmitted to the client device 200 by means of the network transmitter 130.

At this point, before the MPEG compressed moving picture data is transmitted to the client device 200 in the wireless fashion, the data is temporarily stored in a buffer 150.

As the data compressed by the MPEG encoder 120 is stored in the buffer 150, damaged data is not re-compressed and original data associated with the damaged data is obtained from the buffer 150 and re-transmitted when data loss is caused by transmission delay, such that transmission efficiency can be enhanced.

Here, the network transmitter 130 comprises: a transmission state information generation module 131 for generating transmission state information including header information of the moving picture data, transmission bandwidth information, a data compression rate and delay time information; and a communication module 132 for transmitting the moving picture data to the client device 200 in the wireless fashion.

That is, the compressed moving picture data is transmitted to the client device 200 over the communication module 132 in the wireless fashion. The data transmission state information necessary for predicting the transmission bandwidth is generated and the generated data transmission state information is fed back to the compression rate controller 140.

At this point, the transmission state information generated by the transmission state information generation module 131 includes header information (including a transmission time, a data compression rate, a packet number and a transmission delay time) of the moving picture data transmitted to the client device 200, information (including a transmission (Tx) rate, a received signal strength indication (RSSI), a channel rate, etc.) associated with the transmission bandwidth when the transmission operation is performed, and information such as a transmission buffer state, a total delay time, etc. of the server device 100.

When the server device 100 transmits and receives data using an RF signal, the communication module 132 can be implemented by a wireless communication module. On the other hand, when the server device 100 transmits and receives data using a Bluetooth communication protocol, the communication module 132 can be implemented by a Bluetooth communication module.

The communication module 132 can be differently implemented according to a type of network used in the server system for performing communication over the wireless network in accordance with the present invention. The present invention is not limited to the above example.

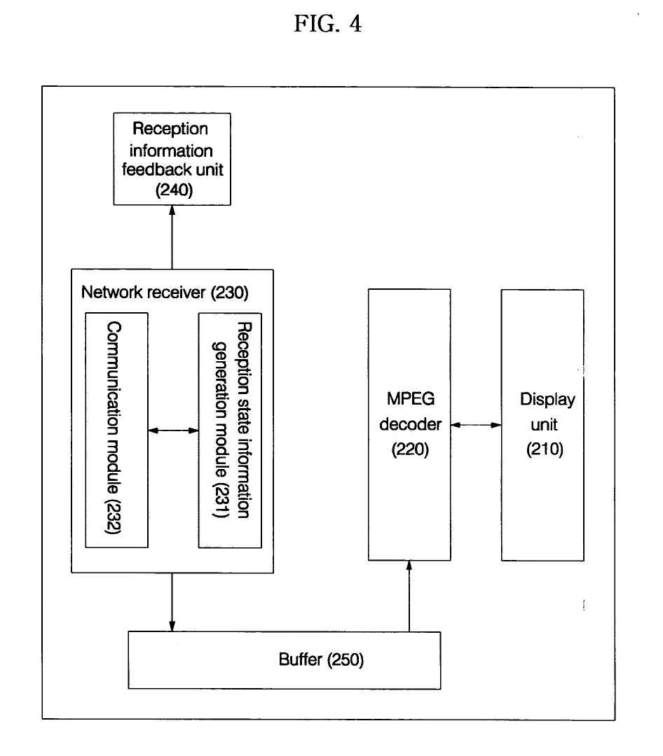

FIG. 4 is a block diagram illustrating the client device in accordance with the present invention.

The moving picture data transmitted over the wireless network from the server device 100 is received by a network receiver 230 of the client device 200 and the received data is decompressed by the MPEG decoder 220 as shown in FIG. 4.

The network receiver 230 comprises: a reception state information generation module 231 for generating reception state information including current reception bandwidth; and a communication module 232 for receiving the moving picture data from the server device 100 in the wireless fashion.

Like the communication module 132 of the server device 100, the communication module 232 can be differently implemented according to a type of network used in the server system for performing communication over the wireless network in accordance with the present invention.

The reception state information generated by the reception state information generation module 231 includes header information (including a transmission time, a packet number, a data compression rate and a transmission delay time) of the received moving picture data, information (including a reception (Rx) rate, a received signal strength indication (RSSI), a wireless channel rate, etc.) associated with the transmission bandwidth of the client device 200, and information such as a reception buffer size, a playback delay time, etc. of the client device 200.

After the received moving picture data is temporarily stored in a buffer 250, the moving picture data compressed according to a variable compression rate used in the MPEG encoder 120 is decompressed by the MPEG decoder 220, such that the data can be reproduced.

The MPEG decoder 220 extracts a compression rate from the header information of the received moving picture data and performs a decoding operation according to the extracted compression rate.

The moving picture data decoded as described above is externally displayed on the display unit 210. If the web pad is employed as the client device, the user can view the moving picture data through the display unit 210 of the web pad.

Here, the network receiver 230 generates the reception state information to correctly measure transmission bandwidth used as a factor determining a compression rate applied to the MPEG encoder 120 of the server device 100. The reception state information is transmitted to the compression rate controller 140 over a reception information feedback unit 240 in the wireless fashion.

That is, the reception information feedback unit 240 predicts the transmission bandwidth of the current network on the basis of the reception state information transmitted to the server device 100 and the transmission state information generated by the network transmitter 130. The transmission bandwidth acts as a first factor necessary for variably controlling the compression rate of the MPEG encoder 120.

Where the client device 200 further comprises an input unit (not shown) for receiving, from the user, an image quality level in which moving picture data is reproduced, the user can input a signal indicating an acceptable image quality level. The image quality level acts as a second factor necessary for variably controlling the compression rate of the MPEG encoder 120.

For example, when the transmission bandwidth of the current wireless network is sufficient and a data transmission operation based on “A” bps is possible, the compression rate controller 140 lowers a data compression rate if the user has inputted an image quality level based on high image quality.

In this case, because an amount of packet data to be transmitted from the server device 100 increases but the transmission bandwidth of the wireless network is sufficient, data can be transmitted to the client device 200 without transmission delay.

If the user lowers the image quality level and varies a data playback environment so that low image quality is acceptable, information set by the user is transmitted to the compression rate controller 140 by the reception information feedback unit 240, such that the compression rate for the moving picture data is increased.

Moreover, when the transmission bandwidth measured by the variation of a wireless network environment is reduced to “A/2” bps, the compression rate controller 140 predicts data transmission bandwidth on the basis of the transmission and reception state information transmitted from the network transmitter 130 and the reception information feedback unit 240.

Accordingly, the compression rate controller 140 increases the compression rate and reduces a size of moving picture data to avoid the transmission delay caused by the reduced transmission bandwidth.

That is, when the data transmission bandwidth is increased and the image quality level is increased, the compression rate controller 140 ensures image quality of the moving picture data to be transmitted by reducing the compression rate. Alternatively, when the transmission bandwidth is reduced by increased transmission load or the image quality level is reduced, the data compression rate is increased, such that the transmission load is reduced and the image quality desired by the user is provided.

Accordingly, as the transmission bandwidth of the current network and the data compression rate of the server device 100 are harmonized with each other, the client device 200 can carry out a playback operation in real time. Moreover, the image quality acceptable by the user can be ensured without loss of the transmitted data.

Because it is difficult for the transmission bandwidth to be correctly measured in the wireless network, not only information indicating the transmission bandwidth from the server device 100 at a data transmitting side, but also information indicating the reception bandwidth measured by the client device 200 at a receiving side is fed back, such that the transmission bandwidth can be correctly produced.

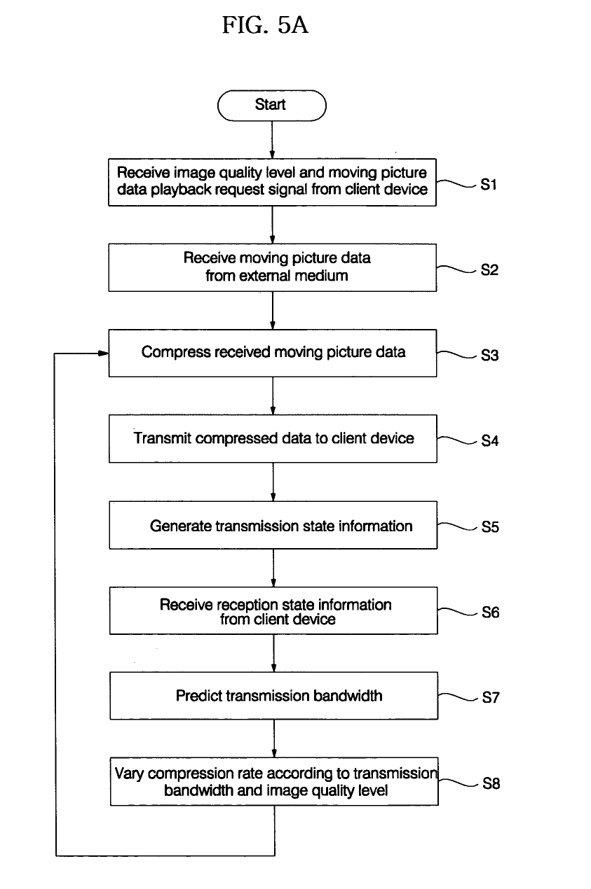

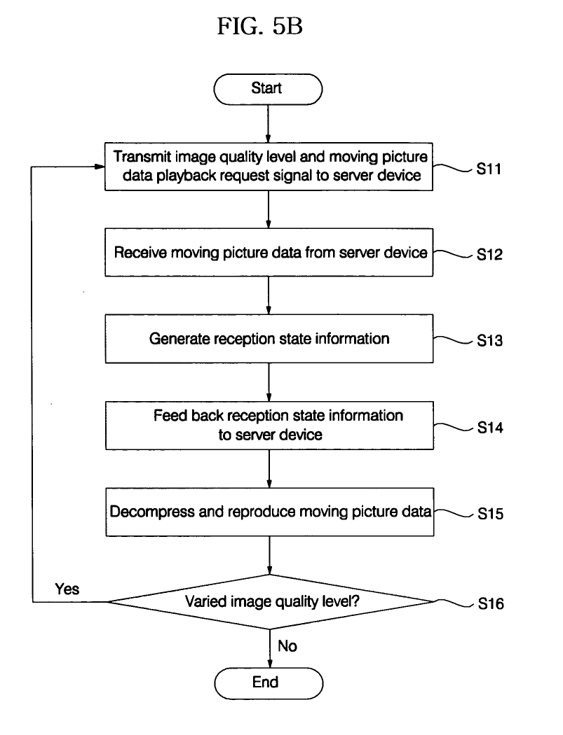

An operating method of the server system for performing communication over the wireless network will be described with reference to FIGS. 5A and 5B.

First, the client device transmits a control signal for a moving picture data playback request and information indicating an image quality level acceptable by the user in the wireless fashion (S11).

At the first step, when the server device receives the moving picture data playback request signal from the client device (S1), it receives the moving picture data such as TV, radio and content media data from an external medium over the Internet network or cable network (S2) and compresses the received moving picture data at a predetermined compression rate (S3).

At the second step, the server device transmits the compressed moving picture data to the client device in the wireless fashion (S4) and generates transmission state information including the transmission bandwidth (S5).

At this point, the compressed moving picture data is transmitted to the client device over the wireless network. The wireless network can employ a wireless communication network using an RF signal or a Bluetooth communication network using a Bluetooth communication protocol.

Moreover, the transmission state information generated by the server device includes header information of data transmitted to the client device, transmission bandwidth information when data is transmitted, and a transmission buffer state, a compression data rate and a total delay time associated with the server device. The transmission state information is used for predicting the transmission bandwidth and producing the data compression rate.

At the third step, the transmission bandwidth can be predicted on the basis of the transmission state information generated at the second step and the reception state information received from the client device (S7).

For this, the third step includes a process for receiving the reception state information including the reception bandwidth fed back from the client device (S6).

That is, the client device receives the moving picture data (S12), generates the reception state information including the data reception bandwidth (S13), and feeds back the generated reception state information to the server device (S14).

At this point, the reception state information includes header information of the moving picture data received by the client device, reception bandwidth information of the client device, a reception buffer size and a playback delay time.

The client device generates the reception state information, and decompresses and reproduces the received moving picture data (S15).

When the image quality of a moving picture is changed (S16), the client device transmits a changed image quality level to the server device (S11), such that the data compression rate of the server device is adjusted.

At the fourth step, the compression rate for the moving picture data is variably controlled according to the transmission bandwidth produced at the third step and the image quality level acceptable by the user at the client device (S8). Then, the method returns to the first step.

Here, the server device determines transmission bandwidth by taking into account time delay required for predicting a transmission network state, time delay required for controlling a transmission rate, and time delay required for collecting display data.

Thus, the server device decides the transmission bandwidth associated with the current wireless network state and the compression rate for the moving picture data based on the image quality level. A compression operation for the continuously received moving picture data is carried out according to a variably controlled compression rate, such that transmission load of the wireless network is reduced and a stable networking operation can be carried out.

That is, the moving picture data is transmitted to the client device in a state where the variable data compression rate is harmonized with the current wireless network state in accordance with the present invention. Moreover, playback delay and picture cutoff/distortion can be avoided when the received moving picture data is reproduced in real time, and appropriate image quality can be ensured.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The present disclosure relates to subject matter contained in Korean Patent Application No. 10-2004-0019411, filed on Mar. 22, 2004, the contents of which are herein expressly incorporated by reference in its entirety.

1. A server system for performing communication over a wireless network, comprising:
at least one client device for transmitting and receiving data over the wireless network constructed within a building, and setting an image quality level acceptable by a user when moving picture data is reproduced; and
a server device for compressing the moving picture data received from an external medium at a variably controlled compression rate according to transmission bandwidth of the current wireless network and the image quality level in response to a request of the client device, and transmitting the compressed moving picture data to the client device in a wireless fashion.

2. The server system according to claim 1, wherein the client device comprises:
a network receiver for receiving the moving picture data from the server device in the wireless fashion and generating reception state information including current reception bandwidth;
a Moving Picture Experts Group (MPEG) decoder for carrying out an MPEG decoding operation to decompress the moving picture data received from the network receiver;
a display unit for displaying the data decompressed by the MPEG decoder; and
a reception information feedback unit for feeding back the reception state information generated by the network receiver to the server device.

3. The server system according to claim 2, wherein the network receiver comprises:
a communication module for receiving the moving picture data from the server device in the wireless fashion; and
a reception state information generation module for generating the reception state information including the current reception bandwidth.

4. The server system according to claim 2, wherein the client device further comprises:
a buffer for temporarily storing the data transmitted from the server device in the wireless fashion.

5. The server system according to claim 2, wherein the client device further comprises:
an input unit for receiving the image quality level for moving picture data playback inputted by the user.

6. The server system according to claim 1, wherein the server device comprises:
an audio/video (AV) memory for receiving a moving picture data stream transmitted over a cable antenna or an Internet network and storing the received data stream;
a Moving Picture Experts Group (MPEG) encoder for compressing the moving picture data stored in the AV memory at a predetermined compression rate;
a network transmitter for transmitting the moving picture data compressed by the MPEG encoder to the client device and generating transmission state information including the current transmission bandwidth; and
a compression rate controller for producing the transmission bandwidth of the current network on the basis of the transmission state information generated from the network transmitter and reception state information transmitted from the client device and variably controlling the compression rate of the MPEG encoder according to the produced transmission bandwidth and the image quality level set in the client device.

7. The server system according to claim 6, wherein the network transmitter comprises:
a communication module for transmitting the moving picture data to the client device in the wireless fashion; and
a transmission state information generation module for generating the transmission state information including header information of the moving picture data, transmission bandwidth information, a data compression rate and a delay time.

8. The server system according to claim 7, wherein the communication module is a wireless communication module transmitting and receiving data using a radio frequency (RF) signal.

9. The server system according to claim 7, wherein the communication module is a Bluetooth communication module transmitting and receiving data using a Bluetooth communication protocol.

10. The server system according to claim 7, wherein the compression rate controller comprises:
a transmission bandwidth decision module for producing the transmission bandwidth of the current network on the basis of the transmission state information generated from the network transmitter and the reception state information transmitted from the client device; and
a compression rate decision module for variably controlling the compression rate of the MPEG encoder according to the produced transmission bandwidth and the image quality level set in the client device.

11. The server system according to claim 6, wherein the server device further comprises:
a buffer for temporarily storing data compressed by the MPEG encoder before the compressed data is transmitted to the client device in the wireless fashion.

12. An operating method of a server system, the server system comprising at least one client device for transmitting and receiving data over a wireless network and a server device for compressing moving picture data received at a predetermined compression rate in response to a request of the client device, and transmitting the compressed moving picture data to the client device in a wireless fashion, the operating method comprising the steps of:
(a) compressing, by the server device, the moving picture data transmitted over an external medium at the predetermined compression rate;
(b) transmitting the compressed moving picture data to the client device in the wireless fashion and generating transmission state information including transmission bandwidth;
(c) determining the transmission bandwidth of the current network according to the transmission state information generated at the step (b) and reception state information received from the client device; and
(d) variably controlling a compression rate for the moving picture data according to the transmission bandwidth and an image quality level acceptable by a user of the client device and returning to the step (a).

13. The operating method according to claim 12, wherein the transmission state information comprises header information of the data transmitted to the client device, transmission bandwidth information when the data is transmitted, a transmission buffer state of the server device, a compression data rate and a total delay time.

14. The operating method according to claim 12, wherein the step (a) comprises the step of:
receiving a control signal for a moving picture data playback request and the image quality level acceptable by the user from the client device.

15. The operating method according to claim 12, wherein the step (c) comprises the step of:
receiving the reception state information including reception bandwidth fed back from the client device.

16. The operating method according to claim 12, wherein the reception state information comprises header information of the moving picture data received by the client device, reception bandwidth information of the client device, a reception buffer size and a playback delay time.
